(19) United States
(12) Patent Application Publication
(10) Pub. No.: US 2014/0108066 A1
(43) Pub. Date: Apr. 17, 2014

(54) TRIP-PLANNING COLLABORATION TOOL

(71) Applicant: Travelbk Pte. Ltd., Singapore (SG)

(72) Inventors: Soo Sing LAM, Singapore (SG); Maw Shium FOO, Singapore (SG); Shi Ming THAM, Singpore (SG); Siang Twang HO, Singpore (SG)

(73) Assignee: Travelbk Pte. Ltd., Singapore (SG)

(21) Appl. No.: 14/022,696

(22) Filed: Sep. 10, 2013

Related U.S. Application Data
(60) Provisional application No. 61/698,980, filed on Sep. 10, 2012.

(51) Int. Cl. G06Q 10/02

(52) U.S. Cl. CPC G06Q 10/02
USPC 705/5

(57) ABSTRACT

In accordance with at least one example, an apparatus may facilitate planning of a trip using a trip-planning coordination unit that may be configured to designate a trip and identify trip-planning participants; a feedback coordination unit that may be configured to seek relevant input from the trip-planning participants and obtain the relevant input from the trip-planning participants; and an itinerary generator that may be configured to generate an itinerary for the designated trip.

### BACKGROUND

Trip planning for a group of people includes many challenges. The challenges increase as the number of potential trip attendees increase, even more so when the potential trip attendees are scattered geographically across a region, a country (or over several countries) and across time zones.

Indeed, in such situations, the trip organizer may spend a tremendous amount of time and effort communicating (e.g., phone calls, text messages, email messages, etc.) with potential trip attendees to confirm travel availability, preferences, restrictions, suggestions, recommendations, and such. Since the information from potential attendees and the proposed trip details may change during the planning process, the trip organizer may find it quite difficult to schedule a trip with an itinerary that meets the attendees' needs and wishes.

### SUMMARY

In accordance with at least one example embodiment, an apparatus that facilitates planning of a trip may include: a trip-planning coordination unit that may be configured to designate a trip and identify trip-planning participants who are invited to participate in the planning of the designated trip; a feedback coordination unit that may be configured to seek relevant input from the trip-planning participants regarding the designated trip and obtain the relevant input from the trip-planning participants regarding the designated trip; and an itinerary generator that may be configured to generate an itinerary for the designated trip based, at least in part, upon the obtained relevant input from the identified trip-planning participants regarding the designated trip.

### BRIEF DESCRIPTION OF THE DRAWINGS

FIG. 1 shows a representation of an example system in which a trip-planning collaboration tool may be implemented in accordance with at least some embodiments of the technologies described herein.

FIG. 2 shows another representation of the example system in which a trip-planning collaboration tool may be implemented in accordance with at least some embodiments of the technologies described herein.

FIG. 3 illustrates an example processing flow of operations implemented by a trip-planning collaboration tool, in accordance with at least some embodiments of the technologies described herein.

FIG. 4 illustrates another example processing flow of operations implemented by a trip-planning collaboration tool, in accordance with the technologies described herein.

FIG. 5 illustrates an example computing device by which trip-planning collaboration tool may be implemented, in accordance with the technologies described herein.

The Detailed Description references the accompanying figures. In the figures, the left-most digit(s) of a reference number identifies the figure in which the reference number first appears. The same numbers are used throughout the drawings to reference like features and components.

### DETAILED DESCRIPTION

Disclosed herein are technologies that facilitate trip-planning collaboration. Using these technologies, an example trip-planning collaboration tool may assist with the coordination and organization of a trip for multiple geographically dispersed individuals. More particularly, the example trip-planning collaboration tool may gather relevant information (e.g., availability dates) from relevant parties (e.g., potential trip attendees or travel agencies). Based upon that gathered information, the example trip-planning collaboration tool may generate an itinerary. Indeed, it may book the trip as well.

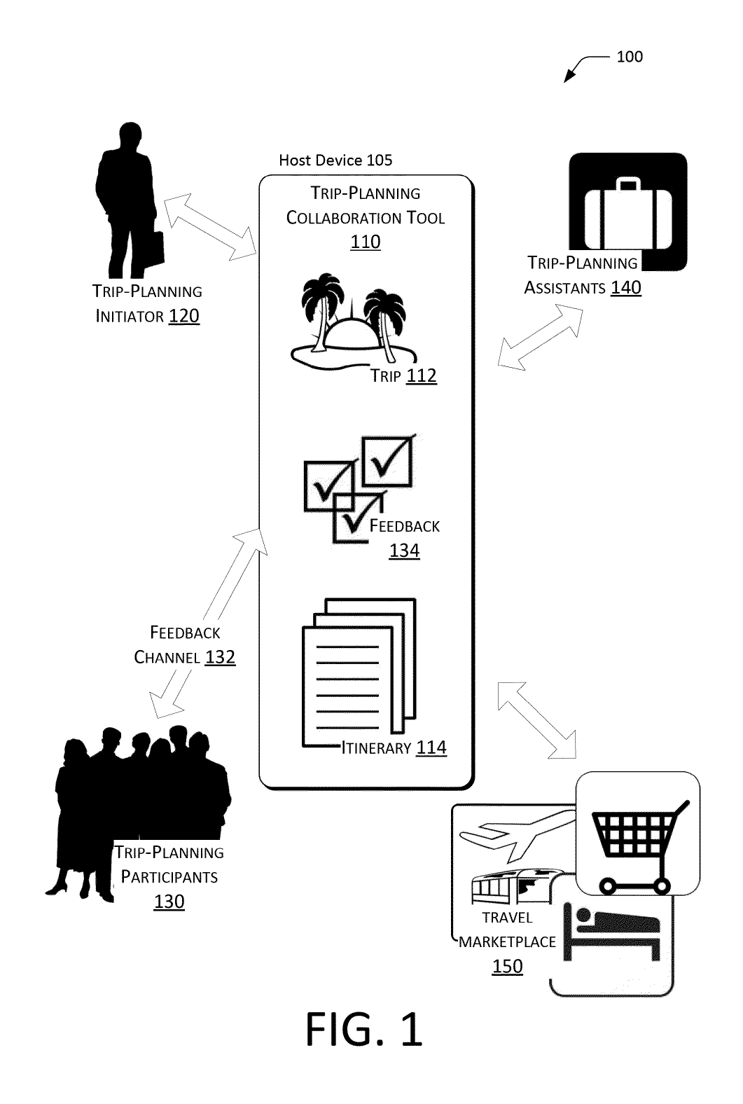

FIG. 1 shows a representation of an example system 100 in which a trip-planning collaboration tool may be implemented. One or more implementations of the technology described herein may be employed in the example trip-planning collaboration system 100.

System 100 includes an example computing device 105 may host an instance of trip-planning collaboration tool 110, which may interact with one or more computing devices corresponding, respectively, to one or more of a trip-planning initiator 120, trip-planning participants 130, trip-planning assistants 140, and a travel marketplace 150. Accordingly, any reference herein to trip-planning initiator 120, one or more of trip-planning participants 130, trip-planning assistants 140, or travel marketplace 150 may be understood to apply to a corresponding computing device under the ownership and/or operating control thereof, on which another instance of trip-planning collaboration tool 110 may be hosted. It should be further understood that system 100 may be configured to communicatively connect all of trip-planning participants 130, trip-planning assistants 140, or travel marketplace 150 to a corresponding travel-planning service provider, at which one or more servers may be hosted, by any one or more of the aforementioned data transmitting and receiving technologies.

As referenced herein, device 105 and the devices corresponding to one or more of trip-planning initiator 120, one or more of trip-planning participants 130, trip-planning assistants 140, and travel marketplace 150 may respectively refer to a mobile or portable electronic devices such as a mobile phone, smartphone, personal digital assistant (PDA) a personal media player device, an application specific device, or a hybrid device that may implement any of the functions described herein, under the ownership and/or operative control of user to which it is attributed in the present description. Such devices may further be respectively implemented as a personal computer including tablet, laptop computer, and non-laptop computer configurations.

Regardless of the implementation, such computing devices may be configured to transmit and receive digital messages over a radio link while moving around a wide geographic area by connecting to a mobile communications network provided by a wireless service provider. In addition to the aforementioned mobile communications, the devices may be configured to transmit/receive data or otherwise share information utilizing non-cellular technologies such as Wi-Fi™, wireless local area network (WLAN or IEEE 802.11), WiMAX™ (Worldwide Interoperability for Microwave Access), Bluetooth™, other analog and digital wireless voice and data transmission technologies, and even wired Ethernet data transmission technologies.

As depicted, the example trip-planning collaboration tool 110 hosted on device 105 may be configured to receive, store, and/or transmit data 112 regarding a proposed trip or event, feedback 134, and an itinerary 114 associated with the trip or event. While data 112, feedback 124, and itinerary 114 may be described as information or data to be transmitted and received, such features may also be regarded as fields and/or button in a user interface (UI) by which a user of device 105 any other device on which an instance of trip-planning collaboration tool 110 may be hosted. That is, trip-planning collaboration tool 110 may include a UI by which a user thereof may enter data, e.g., trip preferences, and/or receive data from other trip-planning participants, e.g., trip-planning participants 130. The UI may receive a user's input via a text input field, using voice input/recognition technologies, etc. Similarly, the UI may display or otherwise share received data in textual or audio form. Accordingly, references to the inputting of data, e.g., preferences, and the receiving of data, e.g., feedback, throughout this description may be understood to be implemented via the UI corresponding to trip-planning collaboration tool 110.

Trip-planning initiator 120 may refer to a user who owns or otherwise exercises operating control over host device 105. Under trip-planning initiator 120, trip-planning collaboration tool may select a proposed trip or event. The trip-planning initiator 120 may select from a list of available, suggested, or desired destinations (e.g., Paris, France), a non-listed destination, a list of available, suggested, or desired events (e.g., a music festival), or a non-listed event or activity. Trip-planning collaboration tool 110 may be configured to generate the list of suggested destinations and/or events in response to the trip-planning initiator 120 selecting some filtering criteria (such as regions, Point of Interest (“POI”), seasons, days of travel, categories of locations, etc.). In addition, trip-planning collaboration tool 110 may be further configured to provide a list of available pre-generated trips (i.e., itineraries), which may be those offered by travel professionals.

The selected proposed trip and/or event may refer to an up-coming journey, event, gathering, or the like. In that sense, the trip may be characterized as at least one or more of the following: a journey, cruise, expedition, outing, tour, junket, voyage, adventure, gathering, conference, concert, excursion, getaway, convention, camping trip, meeting, trek, party, social function, safari, get-together, event, celebration, holiday, vacation, etc.

However, the proposed trip and/or event may alternatively refer to a dataset that describes and/or defines the details of the up-coming journey, event, activity gathering, or the like. Both senses are used herein. The context guides the reader as to which sense the proposed trip and/or event is intended.

As represented in trip-planning collaboration tool 110, the data 112 representing the proposed trip and/or event may include information regarding one or more potential trip attendees, one or more potential destinations and/or events, and information regarding potential times when the one or more potential trip attendees plan to visit the one or more destinations.

Trip-planning initiator 120, via trip-planning collaboration tool 110, may transmit an invitation to one or more trip-planning participants 130 to participate in the planning of the proposed trip and/or event. Typically, the people who own or exercise operative control over devices corresponding to trip-planning participants 130 are people who the trip-planning initiator 120 would like to join the trip (i.e., a potential trip attendee), although they may also include those who are involved in the planning of the trip, but are not necessarily intended to join the trip. The trip-planning initiator 120 may also be a trip-planning participant himself, and in accordance with multiple embodiments described herein, trip-planning initiator 120 may be regarded as a potential trip attendee.

Trip-planning collaboration tool 110 may identify the people who own or exercise operative control over devices corresponding to trip-planning participants 130 by manually entering a person's name and/or contact information (e.g., email address) or selecting particular people from a list of people (such as a list of friends). Alternatively, trip-planning collaboration tool 110 may provide a filtered list of candidates from which trip-planning initiator 120 may select. For example in this alternative, trip-planning collaboration tool 110 may access a database that includes people who have expressed in interest in a trip to a particular destination that is part of the proposed trip and/or event. In another example, trip-planning collaboration tool 110 may access the database that also or alternatively includes people who have indicated availability to travel on the preliminary dates for the proposed trip and/or event. In still another example, trip-planning collaboration tool 110 may list the friends (such as those on a social networking service) of the trip-planning initiator 120.

Trip-planning initiator 120 may utilize trip-planning collaboration tool 100 to solicit relevant input from the identified and/or invited potential attendees from trip-planning participants 130. Accordingly, trip-planning collaboration tool 110 may be configured to generate and/or transmit one or more of the following: an invitation to a particular trip-planning participant, a poll to the invited trip-planning participants, an alert to the invited trip-planning participants, one or more e-mail messages to the invited trip-planning participants, one or more text messages to the trip-planning participants, one or more instant messages to the invited trip-planning participants, one or more messages on a social networking site (e.g., FACEBOOK™), one or more links (e.g., a Uniform Resource Locator (URL)) for the invited trip-planning participants on a social networking site, etc.

Trip-planning collaboration tool 110 may receive feedback 134 from the one or more invited trip-planning participants 130, via feedback channel 132, regarding the proposed trip and/or event. As depicted, feedback channel 132 may represent mediums by which feedback may be transmitted from the invited trip-planning participants 130 including, but not limited to, email messages, instant messages, text messages (e.g., SMS), text, image files, video files, etc.

Accordingly feedback 134, e.g., relevant input may include, but not be limited to, poll results, digital photographs, digital videos, maps, ratings, recommended locations, suggested locations, desired locations, recommended activities, suggested activities, desired activities, recommended events, suggested events, desired events, comments, and questions.

In accordance with at least one embodiment, users may rate places, events, and activities other users have posted by choosing a score. For example, a scoring scale that ranges from one to five may be denoted by, e.g., star graphics, one star for one point. Scores may be aggregated based on the number of scores given by users and displayed for others to see. To prevent biases, an aggregate score may appear when a predetermined number, e.g., five, scores have been submitted. The trip planning initiator, trip-planning assistants, and/or travel hosts may serve as local travel guides. In that capacity, the local travel guides may bring customers along to various points of interest and provide running commentary. Further in that capacity, the local travel guides may be subject to the aforementioned ratings by users using the same graphics mechanism. Users who have consumed the services of the travel host may vote on the travel host to the exclusion of others, in some embodiments. Implementation may come in various modes including emails that may be sent to a user who has engaged the services of the travel host through the TZ platform upon the completion of the services of the travel host. After the user clicks on the link contained inside the email, a page will load requesting the user to vote using the five star scoring mechanisms

In accordance with at least one alternative embodiment, relevant input may include, but not be limited to, plotted points on a dynamic map, which may be dynamically and cooperatively arranged. Within this map plotting, planning participants may be able to determine logistics, such as but not limited to, traveling time, distance and transportation information, depending on the participation level of the local transport authority to the map data provider, or via a third party data provider.

Based upon, at least in part, feedback 134, trip-planning collaboration tool 110 may generate a preliminary version of itinerary 114 for the proposed trip and/or event. In some example embodiments, trip-planning collaboration tool 110 may generate and/or transmit a notification to one or more of invited trip-planning participants 130 regarding the generated itinerary 114. Itinerary 114 itself may be customized or particular-to-particular potential trip attendee or invited trip-planning participant 130, or it may apply to one or more of the potential trip attendees and/or invited trip-planning participants 130. Itinerary 114 may provide details and information about the proposed trip and/or event.

Itinerary 114 may include, for example, the following: flight information (e.g., passenger full names, i.e., names of potential trip attendees; flight dates and times; frequent flyer program numbers; purchase price; confirmation numbers; electronic ticket numbers; etc.); local transportation information (e.g., information regarding local transportation options such as trains, busses, car rentals, taxis, directions, maps, etc.); lodging information (e.g., hotel addresses, contact information, confirmation number, room rate, etc.); travel tour information (e.g., name of tour company or guide, tour dates and times); tour meeting points and ending points; purchase price, confirmation numbers, etc.); suggestions for activities, sightseeing, local customs, shopping, food, etc.; information about scheduled events and activities (e.g., admission ticket information, start times of scheduled events and activities, etc.); digital images related to the destinations; references to other resources (e.g., websites); etc.

Trip-planning collaboration tool 110 may post the preliminary version of itinerary 114 for viewing and printing on a corresponding webpage, which may be secured for viewing only by potential trip attendees and/or invited trip-planning participants 130. Alternatively, trip-planning collaboration tool 110 may transmit itinerary 114 or a notice thereof to the potential trip attendees and/or the invited trip-planning participants 130. Feedback in response to itinerary 114 may be received by trip-planning collaboration tool 110, via feedback channel 132; or a notice regarding finalization of itinerary 114 may be transmitted by trip-planning collaboration tool 110, via feedback channel 132.

Trip planning assistants 140 may refer to a class of trip-planning participants 130 who may participate in trip planning, but who are not intended to be potential trip attendees. Trip-planning assistants 140 may provide information regarding some or all of the suggested destinations and/or events, and/or provide guidance to the trip-planning participants. Trip-planning assistants 140 may include, but not be limited to, online travel guides, travel destination/event hosts, and/or travel agents. In accordance with at least some examples, trip-planning assistants 140 may be located and/or have expertise concerning one or more of the potential destinations and/or events. Thus, trip-planning assistants 140 may offer customized trip plans, suggestions, recommendations, etc., as part of the trip-planning process.

Travel marketplace 150 may refer to one or more travel professionals, e.g., organizations or individuals that have a commercial or civic interest in encouraging travel in general or travel to particular destinations. Non-limiting examples of travel marketplace 150 may include travel agencies, travel partners, tour companies, airlines, car rental companies, train and bus companies, hotels, hostels, event promoters, travel agencies, chambers of commerce, trade associations, consumer travel organizations (e.g., AAA), travel websites, travel media (e.g., magazines and television), travel rating services (e.g., Zagat™), map and navigation services (e.g., Google™ maps), shopping centers, retailers, amusement parks, other tourist attractions, etc.

Travel marketplace 150 may therefore refer to an online forum or community by which trip-planning professionals may offer packages for specific destinations, Point of Interest (“POI”), and/or events. These packages may be amongst those from which trip-planning initiator 120 may pick to start the trip-planning process. Alternatively, these packages may be suggested by the travel professionals or by one or more of trip-planning participants 130 and/or trip-planning assistants 140. The relevance of the package may be based upon pricing or budget, a planned destination, POI, event/activity location, theme, utility, etc. The system may utilize one or more of ratings from users and/or travel marketplace 150. The relevance may also be based upon the timing of the trip.

In accordance with one or more examples, upon the completion of a trip plan, the user may be able to choose from a list of packages that meets the user's requirements based on information gathered throughout the trip planning process. Once the user has selected a package, trip-planning collaboration tool 110 may send the information to various suppliers, e.g., travel marketplace 150. When solicited information has been received from one or more members of travel marketplace 150, the feedback may be sorted, arranged, and sent back to the user for the user to review.

In accordance with one or more further examples, trip-planning initiator 120 may use trip-planning collaboration tool 110 to invite one or more of trip-planning participants 130 to join an online trip-planning session. The online trip-planning session may serve as a placeholder for all activities related to the planning session.

Session activity may refer to an action or activity that maybe associated with the aforementioned trip-planning session such as a message, poll, sharing, or trip invitation. The message may include, for example, an asynchronous text communication amongst the trip-planning participants 130. The poll may include, for example, an online mechanism to ask questions and get, systematically, answers from some or all of the trip-planning participants 130. Sharing may refer to a participant uploading multimedia content (e.g., photos, video, audio, etc.) related to the proposed trip to the online trip-planning session. The one or more trip-planning participants 130 may review, comment, or otherwise provide feedback with regard to the shared content. The trip invitation is an express invitation for one or more trip-planning participants 130 to join at least the trip planning.

In accordance with the one more further example, any number of trip-planning participants 130, which may include trip-planning initiator 120, may communicate with each other via various mechanisms, such as poke, poll, invite, share, and recommendation, using the instances of trip0planning collaboration tool 110 hosted on a corresponding computing device. Feedback 134 may include the response to these commination mechanisms.

A poke may refer to an alert transmitted to someone else (e.g., a friend) or group indicating a desire or intention to communicate, via any one or more of email messages, instant messages, text messages (e.g., SMS), text, image files, video files, etc.

A poll may refer to a sampling or collection of opinions regarding particular topics. Thus, trip-planning collaboration tool 110 may gather and consolidate the responses of a group of invited trip-planning participants in an iterative manner through one or more subsequent sub-polls. A poll may include a communication that provides an option to initiate a trip invitation to plan for a trip. In some instances, a poll response may include as one of the following:
Yes/No poll—either Yes or No;
Checkbox poll;
Rating poll—e.g. rating of number scale (1-7 for example) or like scale (strongly disagree, disagree, neutral, agree, disagree, strongly disagree), for example;
Follow the majority/minority
Alternatively, responses to a topic (e.g., travel period, destination or places) may be gathered amongst a group of trip-planning participants in a simple vote count with regard to multiple poll choices proposed by trip-planning initiator, trip-planning participants and/or trip-planning assistants.

A trip invitation may be transmitted from trip-planning initiator 120, via trip-planning collaboration tool 110, to one or more of trip-planning participants 130 to join the trip itself (and/or join in the planning of the trip). The format of an invite may include an identity of trip-planning initiator 120, a name or title of the proposed trip and/or event, timing of the proposed trip and/or event, location of the proposed trip and/or event, a theme of the proposed trip and/or event, POI associated with the proposed trip and/or event, etc.

Any one of trip-planning initiator 120 and/or trip-planning participants 130 may select content (e.g., images, video, audio, text, etc.) and shares it with another person or a group via popular social media outlets such as TWITTER™, FACEBOOK™, LINKEDIN™, WEIBO™, etc. The actual item shared may include digital content and/or links thereto hosted by the sharer's account. Non-limiting examples of such content may include: (i) General Location/Maps, (ii) Promotions, (iii) Activities/Events/Calendar items, (iv) Album/Journal, (v) Picture/Video file and (vi) Trip Plans.

A recommendation may refer to feedback that is customized for the trip-planning participant who proposes the recommendation for the trip. In one or more examples, a person may suggest or advise one or more of the following for the trip being planned: (i) food and beverage (F&B) outlets—restaurants and eateries, (ii) food menu items, (iii) shopping places, (iv) shopping items, (v) attractions/places of interests—such as buildings, monuments, etc., (vi) entertainment, (vii) promotions, and other activity-related attractions.

In some examples, trip-planning collaboration tool 110 may extract additional information based upon the feedback 134 from the trip-planning participants 130. This additional information may be obtained from an existing database of the tool 110 or it may be pulled in from external sources (e.g., the Internet). The content of the additional information may include digital photos, videos, menus, maps, related websites, online stores, etc. that are related to the details of the trip and/or the feedback 134.

Trip-planning collaboration tool 110 may create an interim trip plan, which may be also be referenced as a trip folio herein. The trip folio is a repository for all data and feedback regarding the trip (e.g., trip details, trip attendees, requested activities, available travel days and times, etc.). The trip folio may also include shared items such as photos, recommendations, videos, blogs, and the like.

Trip-planning initiator 120 and, in some examples, the trip-planning participants may view the data of the trip folio, which may provide a status of the trip planning. The trip folio may list those who have accepted, declined or tentatively accepted the invitation to join the trip; provide a calendar or schedule on which trip-planning participants may chose times/days that they are or are not available for travel; and/or include results of polls of the trip-planning participants. In addition, the respondents may propose appropriate time slot or dates for the trip, which may be in the form of a vote or binary poll. The trip folio may include other feedback from the trip-planning participants.

The trip itinerary 114 may be regarded as a finalized outcome of the planning transaction done with or without an online session on which the trip-planning participants may agree upon items included itinerary 114. Hence, a trip plan may involve multiple Points of Interest (“POI”) including attractions, F&B outlets, hotels, shops or even organized tours/sporting activities like fishing or other events.

Apart from general description and information, e.g., address, opening hours, etc., a page dedicated to a particular Point of Interest (POI) may show multiple streams of information including, but not limited to, activities in which visitors may participate and events that visitors may attend. The aforementioned details may be provided and/or maintained by a system administrator, a POI administrator, an open source community, etc.

Users browsing information the POI home page may easily see what are the interesting Activities or Events at the POI and include them in a trip plan itinerary. For example, a user is attracted to an Event shown and the user can quickly use that Event to initiate a new trip plan and invite friends to participate in the trip.

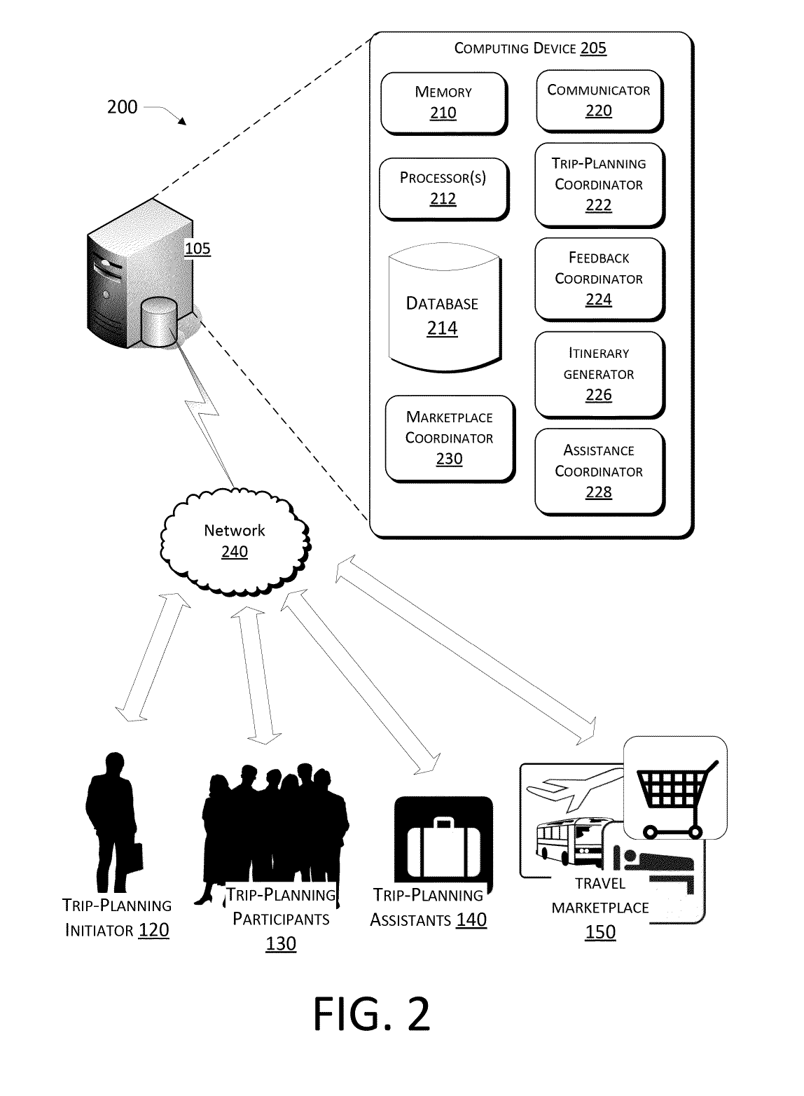

Further, trip-planning collaboration tool 110 may further include a customer relationship management component that may be configured to connect any one of trip planning initiator 120, trip planning participants 130, trip-planning assistants 140, or individual entities from travel marketplace 150 to a customer care representative or component, as described with regard to FIG. 2. In particular, the customer relationship management component may be configured to provide profile information for trip-planning initiator 120, one or more of trip-planning participants 130, or one or more of trip-planning assistants 140 to the trip-planning service provider; provide at least a partial record of trip-planning activities corresponding to any one of trip-planning initiator 120, one or more of trip-planning participants 130, or one or more of trip-planning assistants 140 to the trip-planning service provider; booking and payment history for any one of trip-planning initiator 120, one or more of trip-planning participants 130, or one or more of trip-planning assistants 140 to the trip-planning service provider, to the aforementioned customer care representative or customer care tool associated with the trip-planning service provider. Accordingly, one or more of trip-planning initiator 120, trip-planning participants 130, or trip-planning assistants 140 may be able to make changes and amendments or cancellations as part of the reservation process.

FIG. 2 shows another representation of the example system in which a trip-planning collaboration tool may be implemented, in accordance with at least some embodiments of the technologies described herein. System 200 may incorporate features depicted and described in connection with FIG. 1, but the embodiments described herein are not so limited. Accordingly, system 200 may include a computing device 105 and a network 240 though which several entities (such as the trip-planning initiator 120, the trip-planning participants 130, the trip-planning assistants 140, and the travel marketplace 150) communicate therewith.

Computing device 205 may refer to a computing system such as a desktop computer, a laptop, a tablet computer, a mobile device (such as a so-called smartphone), or some combination of such devices. Computing device 105 may include a memory 210, one or more processor(s) 212, a database 214, a communicator 220, a trip-planning coordinator 222, a feedback coordinator 224, an itinerary generator 226, an assistance coordinator 228, and a marketplace coordinator 230, all of which may be provided separately, in various combinations, or even with some eliminated. Further, the functional components may be implemented, at least in part, as software, firmware, and/or hardware, and thus may be stored in the memory 210 and executed by the processors 212.

Database 214 may be configured to store datasets of associated data. More particularly, database 214 may collect relevant data and/or feedback 134 from one or more of trip-planning participants 130, the relevant input being associated with the proposed trip and/or event. The collected data and/or feedback 134 may be received in the form of email messages, instant messages, text messages, text, images, video, etc. Database 214 may also store details of and information concerning the trip folio and the generated itinerary 114.

Further, database 214 may store particular preferences, settings, and favorites of a user of trip-planning initiator 120 or one or more of trip-planning participants 130. Database 214 may store data pertaining to relationships amongst trip-planning initiator 120, trip-planning participants 130, and/or the potential trip attendees.

Further still, in accordance with at least some embodiments, trip planning collaboration tool 110 may serve as a sharing tool. For instance, database 214 may store pictures, videos, comments, etc., to be shared within a trip planning session. Any one of the trip initiator and/or trip planning participants may link any portion of the stored content to a trip planning session, which may be organized into an individual or group album that may be arranged chronologically or linked to a trip itinerary (e.g. specific points of interests), using time stamps or geo-tags. A user may also manually tag the links to the trip itinerary. The albums may also be viewed after a trip, to be shared with trip participants or friends of the community.

Communicator 220 may be configured to facilitate communications between the instance of trip-collaboration tool 110 hosted on computing device 105,across network 240, and one or more trip-planning participants 130, trip-planning assistants 140, travel marketplace 150, etc. Communicator 220 may be further configured to facilitate interactions amongst the various communication parties. For example, communicator 220 may manage the online trip-planning sessions described herein. Furthermore, the communicator 220 may manage the lower-level aspects of the communication mechanisms of the trip invite, poke, poll, share, recommendation and the feedback therefrom, as described herein.

Trip-planning coordinator 222 be configured to generate a list of suggested destinations in response to the trip-planning initiator 120 selecting one or more filtering criteria (e.g., regions, particular events, seasons, days of travel, POI, categories of locations, etc.). Thus, trip-planning coordinator 222may be configured to facilitate trip-planning initiator's 120 selection of a destination for the proposed trip and/or event.

Trip-planning coordinator 222 may be configured to further facilitate identification (e.g., selection) of one or more trip-planning participants 130 who are invited to participate in the planning of the proposed trip and/or event.

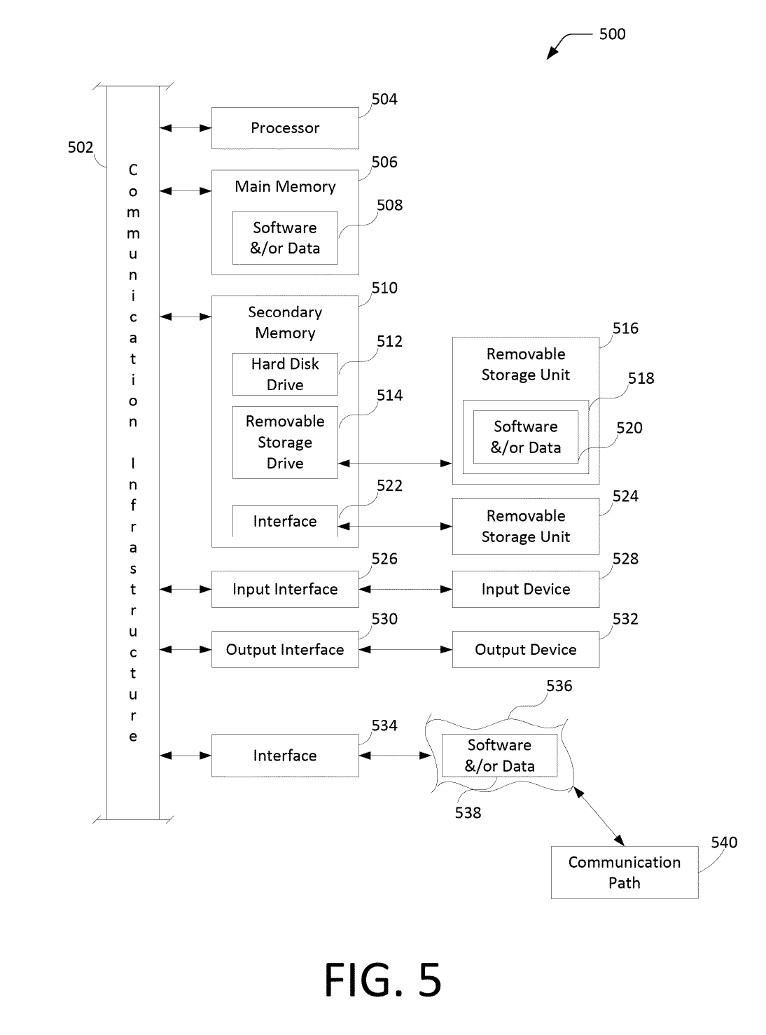

In at least one alternatively embodiment, trip-planning coordinator 222 may be further configured to serve as a customer care component. In such role, trip-planning coordinator 222 may receive profile information for trip-planning initiator 120, one or more of trip-planning participants 130, or one or more of trip-planning assistants 140 to the trip-planning service provider; at least a partial record of trip-planning activities thereof; booking and payment history thereof; etc. Accordingly, as a customer-care component, trip-planning coordinator may facilitate changes and amendments or cancellations as part of the reservation process. Thus, via any one or more of the data transmitting and receiving technologies described in accordance with, e.g., FIG. 1 and/or FIG. 5, trip-planning coordinator 222 may facilitate changes to itinerary 114 relative to any entity included among travel marketplace 150, a hotel, airline, or any other related travel service industry partner related to the planned trip or event. Trip-planning coordinator may further facilitate communications between any one of trip-planning initiator 120, one or more of trip-planning participants 130, or one or more of trip-planning assistants 140 with one or the aforementioned travel service industry partners, in either a real-time manner or as a third-party facilitator.

Feedback coordinator 224 may facilitate soliciting and receiving of feedback (i.e., relevant input) from one or more of trip-planning participants 130 regarding the proposed trip and/or event, including, but not limited to, poll results, digital photographs, digital videos, maps, ratings, recommended locations, suggested/desired activities, comments, and questions. Feedback coordinator 224 may be configured to facilitate proactive and reactive aspects of requests for relevant input. Still, in accordance with some examples, feedback coordinator may be incorporated into communicator 220.

Itinerary generator 226 may be configured to generate itinerary 114 for the proposed trip and/or event based, at least in part, upon the obtained relevant input from the one or more trip-planning participants 130. At least one version of itinerary 114 may be generated for a particular one of the potential trip attendees, and at least one version of itinerary 114 may be generated to include information concerning multiple potential trip attendees. Regardless, the generated itinerary 114 may provide details and necessary information regarding the proposed trip and/or event.

Itinerary generator 226 may be further configured to facilitate or effect booking, reserving, and/or purchasing of various items on itinerary 114, such as airline tickets, lodging reservations, tours, activities, and/or other accommodations for travel and/or lodging. That is, itinerary generator 226 may be configured to communicate with travel websites, airline websites, hotel websites, etc., to book, purchase, or reserve such items on itinerary 114.

Assistance coordinator 228 may be configured to facilitate interactions between one or more of trip-planning assistants 140 and trip-planning initiator 120, one or more of trip-planning participants 130, and/or one or more of the potential trip attendees. For example, one or more of trip-planning assistants 140 may provide suggested destinations and/or provide guidance to the trip-planning participants 130, via assistance coordinator 228.

Marketplace coordinator 230 may be configured to facilitate interactions between travel marketplace 150 and trip-planning initiator 120, one or more of trip-planning participants 130, and/or one or more of the potential trip attendees. Alternatively, the marketplace coordinator 230 may handle the coordination of a bidding process.

Marketplace coordinator 230 may be configured to provide trip-planning assistants with structured or unstructured feedback of the interactions between travel marketplace 150 and trip-planning initiator 120, trip-planning participants 130 or potential trip attendees. Such feedback provided to the trip-planning assistants may tailor information, including customized trip plans, suggestions, and recommendations, targeted at more popular or trending popular destinations, events or activities. Marketplace coordinator 230 may be configured to provide trip-planning assistants with the capability to market and aggregate interest or participation amongst trip-planning initiator, trip-planning participants or potential trip attendees in customized trip plans.

Thus, while trip-planning collaboration tool 110 may incorporate multiple components or modules to facilitate specific channels of communication, such as assistance coordinator 228, alternative embodiments may contemplate one or more of trip-planning coordinator 222, feedback coordinator 224, assistance coordinator 228, and marketplace coordinator 230 being incorporated into communicator 220.

Network 240 may be a wired and/or wireless network. It may include the Internet infrastructure and it may be presented as the so-called “cloud.” Network 240 may include wired or wireless local area network, a cellular network, and/or the like. The network 240 links the computing device 205 with the trip-planning initiator 120, the trip-planning participants 130, the trip-planning assistants 140, and the travel marketplace 150.

As depicted, computing device 205 is shown as a single device and its various components (e.g., database 214, communicator 220, trip-planning coordinator 222, feedback coordinator 224, itinerary generator 226, assistance coordinator 228, and marketplace coordinator 230) are shown as part of that single device. It is contemplated that some or many of the components may be implemented across many devices and locations. Indeed, some or all of the components (including the database) may be implemented on multiple distributed devices and computers and on the so-called cloud.

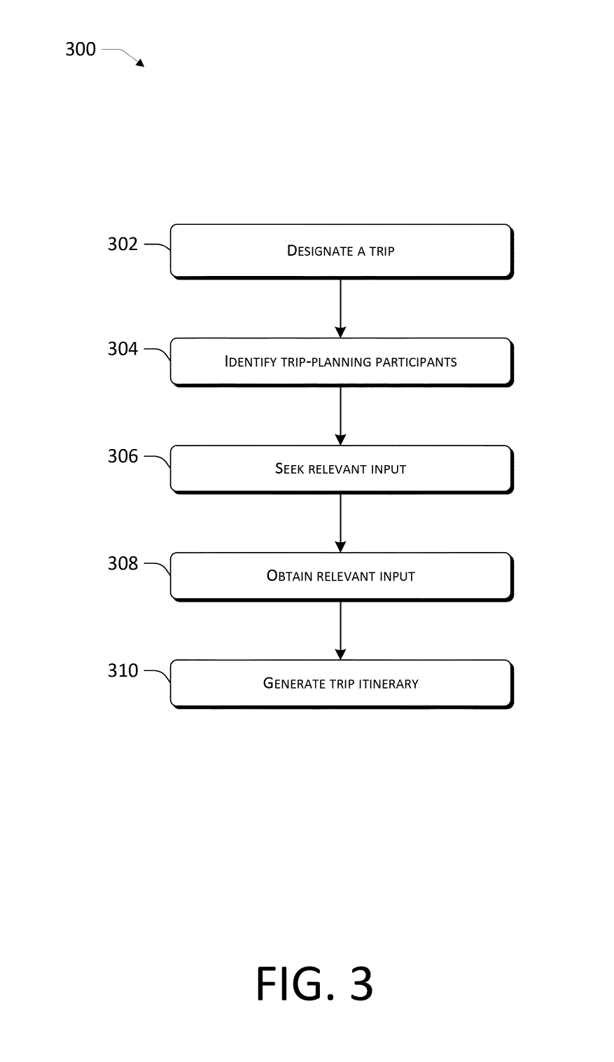

FIG. 3 illustrates an example processing flow of operations implemented by a trip-planning collaboration tool, in accordance with at least some embodiments of the technologies described herein. In particular, process 300 depicts an operation of trip-planning collaboration system 110 implemented by, for example, computing system 105. However, processing flow 300 is not limited to such components, and modification may be made by re-ordering two or more of the sub-processes described here, eliminating at least one of the sub-processes, adding further sub-processes, substituting components, or even having various components assuming sub-processing roles accorded to other components in the following description. Processing flow 300 may include various operations, functions, or actions as illustrated by one or more of blocks 302, 304, 306, 308, and 310. Processing may begin at block 302.

Block 302 (Designate a Trip) may refer to trip-planning collaboration system 110 designating a potential trip and/or event. The designating may include receiving a location and/or a time frame for travel from trip-planning initiator 120. In some embodiments, the trip designating may be preceded by trip-planning collaboration system 110 finding an association between an event and multiple people. Then the system designates a proposed trip that encompasses (e.g., includes) that event. Processing may proceed from block 302 to block 304.

Block 304 (Identify Trip-Planning Participants) may refer to trip-planning collaboration system 110 inviting one or more of trip-planning participants 130 to participate in the planning of the proposed trip and/or event. Thus, block 304may include trip-planning initiator 120 providing data (such as email addresses) to identify people to invite to participate in the planning of the designated trip 112. In some examples, one or more trip-planning participants 130 may include the people associated with the found event. In some embodiments, the identification of participants may be preceded by trip-planning collaboration system 110 finding an association between an event and multiple people (e.g. friends) or a location and multiple people (e.g. friends).

Alternatively, block 304 may further refer to trip-planning collaboration system 110 finding an association between the proposed trip and/or event and one or more trip-planning assistants 140, e.g., such as trip-planning professionals, who may be included as one of the one or more identified trip-planning participants 130. The association may be, for example, a respective professional's expertise in or knowledge of the region of the destination. Processing may proceed from block 304 to block 306.

Block 306 (Seek Relevant Input) may refer to trip-planning collaboration system 110 seeking relevant input from the one or more trip-planning participants 130 and/or trip-planning assistants 140 regarding the proposed trip and/or event. The request may be for an indication of a person's interest and/or willingness to participate in the planning of the potential trip and/or event, or even to join the potential trip and/or event as a potential attendee. Thus, block 306 may refer to one or more of the following actions: inviting one or more of trip-planning participants 130 and/or trip-planning assistants 140 to join the designated trip, polling those invited, sending an alert to those invited, sending an e-mail message to those invited, sending a text message to those invited, sending an instant message to those invited, posting a message on a social networking site, and/or linking to content (using a URL) to data accessible only to those invited on a social networking web service. Processing may proceed from block 306 to block 308.

Block 308 (Obtain Relevant Input) may refer to trip-planning collaboration system 110 obtaining the requested relevant input, e.g., feedback, regarding the designated trip 112. The obtained relevant input may include an acceptance from at least one of the trip-planning participants 130 and/or trip-planning assistants 140 to the aforementioned invitation. The obtained relevant input may include one or more proposed alternative time frames for the designated trip 112, poll results, digital photographs, digital videos, maps, ratings, recommended locations, suggested activities, comments, questions, etc. The one or more trip-planning assistants 140 may provide specific tours, transportation, accommodations, etc., as part the relevant input. Processing may proceed from block 308 to block 310.

Block 310 (Generate Trip Itinerary) may refer to trip-planning collaboration system 110 generating itinerary 114 for the proposed trip and/or event based, at least in part, upon the obtained relevant input.

In some examples, trip-planning collaboration system 110 may post the itinerary 114 in an online forum, and/or transmit itinerary 114 or a notice thereof to the potential trip attendees and/or the trip-planning participants 130. In some examples, trip-planning collaboration system 110 may transmit itinerary 114 (or a portion thereof) to one or more travel agencies, booking agents, and/or travel website for the purpose of making the necessary travel arrangements. In some other implementations, the system may, on behalf of the attendees, directly book, reserve, and/or purchase the items referenced in the itinerary that need booking, reserving, and/or purchasing.

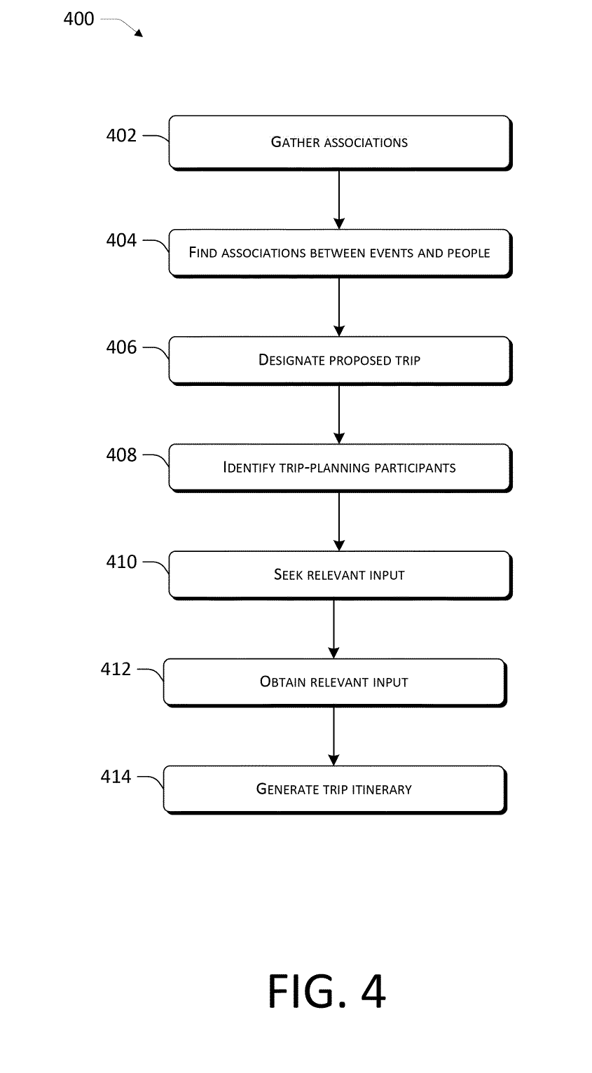

FIG. 4 illustrates another example processing flow 400 of operations implemented by a trip-planning collaboration tool, in accordance with the technologies described herein. In particular, process 400 depicts another example processing flow implemented by trip-planning collaboration system 110. However, processing flow 400 is not limited to such components, and modification may be made by re-ordering two or more of the sub-processes described here, eliminating at least one of the sub-processes, adding further sub-processes, substituting components, or even having various components assuming sub-processing roles accorded to other components in the following description. Processing flow 400 may include various operations, functions, or actions as illustrated by one or more of blocks 402, 404, 406, 408, 410, 412, and 414. Processing may begin at block 402.

Block 402(Gather Associations) may refer to trip-planning collaboration system 110 gathering and storing in, e.g., database 214, associations between potential trip attendees and trip-related interests and preferences. One or more potential trip attendees, or even one or more of trip-planning participants 130 or trip-planning assistants 140, may indicate a preference for particular POIs (e.g., the Space Needle, the Grand Canyon, etc.); destinations (e.g., New York, Tokyo, London, etc.); or regions (e.g., New England). One or more potential trip attendees, or even one or more of trip-planning participants 130 or trip-planning assistants 140 may further or alternatively express a preference for one or more particular events (e.g., the Super Bowl; Tour de France; Running of the Bulls in Spain; the Fringe Festival in Scotland; Mardi Gras in New Orleans). One or more potential trip attendees, or even one or more of trip-planning participants 130 or trip-planning assistants 140 may further express other preferences, such as available travel dates or preferred travel mates. These stored associations regarding at least the potential trip attendees may, in turn, be compiled in database 214. Processing may proceed from block 402 to block 404.

Block 404 (Find Associations Between Events and People) may refer to trip-planning collaboration system 110 searching database 214 for an association between an event and at least one or more of the potential trip attendees, or even one or more of trip-planning participants 130 or trip-planning assistants 140. Processing may proceed from block 404 to block 406.

Block 406 (Designate Proposed Trip) may refer trip-planning collaboration system 110 utilizing the associations to propose a trip and/or event. Alternatively, block 406 may include trip-planning collaboration system 110selecting a proposed trip from a group of pre-generated trips and/or event, which may or may not be provided by one or more trip-planning assistants 140.

As used herein in this context, a proposed trip may encompass a particular event when the proposed trip includes travel to and from the event, other travel needs at/near the event (e.g., lodging), and any other reasonable needs for the event (e.g., tickets to the event). For example, if the event is the Super Bowl, the proposed trip may include travel to the game site in advance of the game and return travel afterwards, lodging near the event, and game tickets. Processing may proceed from block 406 to block 408.

Block 408 (Identify Trip-Planning Participants) may refer to trip-planning collaboration system 110 identifying one or more trip-planning participants 130 who are invited to participate in the planning of the proposed trip and/or event. The one or more trip-planning participants 130 may include people associated with the found event.

Alternatively, block 408 may refer to trip-planning collaboration system 110 finding an association between the designated trip and one or more of trip-planning assistants 140 (e.g., trip-planning professionals) who may then be included as one or more of the identified trip-planning participants 130. The association may be, for example, the professional's expertise in or knowledge of the region of the destination. Processing may proceed from block 408 to block 410.

Block 410 (Seed Relevant Input) may refer to trip-planning collaboration system seeking relevant input from one or more of trip-planning participants 130 and/or one or more of trip-planning assistant 140 regarding the proposed trip and/or event. Thus, block 410 may include transmitting a request to one or more of trip-planning participants 130 and/or trip-planning assistants 140 to participate in the planning. Processing may proceed from block 410 to block 412.

Block 412 (Obtain Relevant Input) may refer to trip-planning collaboration system 110 obtaining the relevant input, e.g., feedback. Processing may proceed from block 412 to block 414.

Block 414 (Generate Trip Itinerary) may refer to trip-planning collaboration system 110 generating itinerary 114 for the designated trip based, at least in part, upon the obtained relevant input from the identified trip-planning participants 130 regarding the designated trip 112.

FIG. 5 illustrates an example computing device by which trip-planning collaboration tool may be implemented, in accordance with the technologies described herein. The computer system 500 includes one or more processors, such as processor 504. Processor 504 can be a special purpose processor or a general-purpose processor. Processor 504 is connected to a communication infrastructure 502 (for example, a bus or a network). Depending upon the context, the computer system 400 may also be called a client device.

Computer system 500 also includes a main memory 506, preferably Random Access Memory (RAM), containing possibly inter alia computer software and/or data 508.

Computer system 500 may also include a secondary memory 510. Secondary memory 510 may include, for example, a hard disk drive 512, a removable storage drive 514, a memory stick, etc. A removable storage drive 514 may comprise a floppy disk drive, a magnetic tape drive, an optical disk drive, a flash memory, or the like. A removable storage drive 514 reads from and/or writes to a removable storage unit 516 in a well-known manner. A removable storage unit 516 may comprise a floppy disk, magnetic tape, optical disk, etc. which is read by and written to by removable storage drive 514. As will be appreciated by persons skilled in the relevant art(s) removable storage unit 516 includes a computer usable storage medium 518 having stored therein possibly inter alia computer software and/or data 520.

In alternative implementations, secondary memory 510 may include other similar means for allowing computer programs or other instructions to be loaded into computer system 500. Such means may include, for example, a removable storage unit 524 and an interface 522. Examples of such means may include a program cartridge and cartridge interface (such as that found in video game devices), a removable memory chip (such as an Erasable Programmable Read-Only Memory (EPROM), or Programmable Read-Only Memory (PROM)) and associated socket, and other removable storage units 524 and interfaces 522 which allow software and data to be transferred from the removable storage unit 524 to computer system 500.

Computer system 500 may also include an input interface 526 and a range of input devices 528 such as, possibly inter alia, a keyboard, a mouse, etc.

Computer system 500 may also include an output interface 530 and a range of output devices 532 such as, possibly inter alia, a display, one or more speakers, etc.

Computer system 500 may also include a communications interface 534. Communications interface 534 allows software and/or data 538 to be transferred between computer system 500 and external devices. Communications interface 534 may include a modem, a network interface (such as an Ethernet card), a communications port, a Personal Computer Memory Card International Association (PCMCIA) slot and card, or the like. Software and/or data 538 transferred via communications interface 534 are in the form of signals 536 which may be electronic, electromagnetic, optical, or other signals capable of being received by communications interface 534. These signals 536 are provided to communications interface 534 via a communications path 540. Communications path 540 carries signals and may be implemented using wire or cable, fiber optics, a phone line, a cellular phone link, a Radio Frequency (RF) link or other communications channels.

As used in this document, the terms “computer-program medium,” “computer-usable medium,” and “computer-readable medium” generally refer to media such as removable storage unit 516, removable storage unit 524, and a hard disk installed in hard disk drive 512. Computer program medium and computer usable medium can also refer to memories, such as main memory 506 and secondary memory 510, which can be memory semiconductors (e.g. Dynamic Random Access Memory (DRAM) elements, etc.). These computer program products are means for providing software to computer system 500.

Computer programs (also called computer control logic) are stored in main memory 506 and/or secondary memory 510. Such computer programs, when executed, enable computer system 500 to implement the present technology described herein. In particular, the computer programs, when executed, enable processor 504 to implement the processes of aspects of the above. Accordingly, such computer programs represent controllers of the computer system 500. Where the technology described herein is implemented, at least in part, using software, the software may be stored in a computer program product and loaded into computer system 500 using removable storage drive 514, interface 522, hard drive 512 or communications interface 534.

The technology described herein may be implemented as computer program products comprising software stored on any computer useable medium. Such software, when executed in one or more data processing devices, causes data processing device(s) to operate as described herein. Embodiments of the technology described herein employ any computer useable or readable medium, known now or in the future. Examples of computer useable mediums include, but are not limited to, primary storage devices (e.g., any type of random access memory), secondary storage devices (e.g., hard drives, floppy disks, Compact Disc Read-Only Memory (CD-ROM) disks, Zip disks, tapes, magnetic storage devices, optical storage devices, Micro-electro-mechanical Systems (MEMS), and nano-technological storage device, etc.)).

A computing system may take the form of any combination of one or more of inter alia a wired device, a wireless device, a mobile phone, a feature phone, a smartphone, a tablet computer, a mobile computer, a handheld computer, a desktop computer, a laptop computer, a server computer, an in-vehicle (e.g., audio, navigation, etc.) device, an in-appliance device, a Personal Digital Assistant (PDA), a game console, a Digital Video Recorder (DVR) or Personal Video Recorder (PVR), cable system or other set-top-box, an entertainment system component such as a television set, etc.

The narrative presented herein is for purposes of illustration only and it will be readily apparent to one of ordinary skill in the relevant art that numerous alternatives (involving for example other components, different component arrangements, additional component interactions, etc.) are easily possible.

In the above description of exemplary implementations, for purposes of explanation, specific numbers, materials configurations, and other details are set forth in order to better explain the present invention, as claimed. However, it will be apparent to one skilled in the art that the claimed invention may be practiced using different details than the exemplary ones described herein. In other instances, well-known features may be omitted or simplified to clarify the description of the exemplary implementations.

The inventors intend the described exemplary implementations to be primarily examples. The inventors do not intend these exemplary implementations to limit the scope of the appended claims. Rather, the inventors have contemplated that the claimed invention might also be embodied and implemented in other ways, in conjunction with other present or future technologies.

Moreover, the word “exemplary” is used herein to mean serving as an example, instance, or illustration. Any aspect or design described herein as exemplary is not necessarily to be construed as preferred or advantageous over other aspects or designs. Rather, use of the word “exemplary” may be intended to present concepts and techniques in a concrete fashion. The term “technology,” for instance, may refer to one or more devices, apparatuses, systems, methods, articles of manufacture, and/or computer-readable instructions as indicated by the context described herein.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

Note that the order in which the processes are described is not intended to be construed as a limitation, and any number of the described process blocks can be combined in any order to implement the processes or an alternate process. Additionally, individual blocks may be deleted from the processes without departing from the spirit and scope of the subject matter described herein.

One or more embodiments described herein may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

We claim:

1. An apparatus that facilitates planning of a trip, comprising:
a trip-planning coordination unit configured to:
designate a trip, and
identify trip-planning participants who are invited to participate in the planning of the designated trip;
a feedback coordination unit configured to:
seek relevant input from the trip-planning participants regarding the designated trip, and
obtain the relevant input from the trip-planning participants regarding the designated trip; and
an itinerary generator configured to generate an itinerary for the designated trip based, at least in part, upon the obtained relevant input from the identified trip-planning participants regarding the designated trip.

2. An apparatus according to claim 1, wherein the trip designation includes data specifying a location and a time frame for travel to that location, which were provided by a trip-planning initiator.

3. The apparatus of claim 1, wherein the feedback coordination unit is configured to seek relevant input by:
inviting the trip-planning participant to join the designated trip,
polling the trip-planning participants, sending an alert to the trip-planning participants,
sending an e-mail message to the trip-planning participants,
sending a text message to the trip-planning participants,
sending an instant message to the trip-planning participants,
posting a message on a social networking web service, or
linking the trip-planning participants to a post on a social networking web service.

4. The apparatus of claim 1, wherein the obtained relevant input includes at least one of poll results, digital photographs, digital videos, maps, ratings, recommended locations, suggested activities, comments, or questions.

5. The apparatus of claim 1, further comprising a database configured to collect the relevant input from the trip-planning participants that are associated with the designated trip.

6. The apparatus of claim 1, wherein the content of the generated itinerary for the designated trip includes at least travel and accommodation confirmation information.

7. The apparatus of claim 1, wherein a trip includes travel to attend an event.

8. A computer-readable medium storing processor-executable instructions that when executed cause one or more processors to perform operations that facilitate planning of a trip, comprising:
designating a trip;
inviting trip-planning participants;
requesting relevant input from the trip-planning participants;
obtaining the requested relevant input from the trip-planning participants;
generating an itinerary for the designated trip based, at least in part, upon the obtained relevant input from the identified trip-planning participants regarding the designated trip.

9. The computer-readable medium of claim 8, wherein the designating includes receiving a location specified by a trip-planning initiator.

10. The computer-readable medium of claim 8, wherein the inviting includes transmitting invitations to people identified by a trip-planning initiator.

11. The computer-readable medium of claim 8, wherein the requesting includes requesting the trip-planning participants to confirm their participation in planning the designated trip.

12. The computer-readable medium of claim 8, wherein the requesting includes:
transmitting a poll to the trip-planning participants,
transmitting an e-mail to the trip-planning participants,
transmitting a text message to the trip-planning participants, or
posting a message on a social networking site.

13. The computer-readable medium of claim 8, wherein the obtained relevant input includes confirmation from at least one of the trip-planning participants regarding participation in planning the designated trip.

14. The computer-readable medium of claim 8, wherein the obtained relevant input includes feedback regarding the designated trip.

15. The computer-readable medium of claim 8, wherein the obtained relevant input is received in the form of at least one of poll results, an email, a text message, or a message on a social networking site.

16. The computer-readable medium of claim 8, wherein the invited trip-planning participants include, at least, professional trip-planners.

17. The computer-readable medium of claim 8, wherein the invited trip-planning participants include travel industry representatives.

18. The computer-readable medium of claim 17, wherein the travel industry representatives include one or more of travel agents, hotel representatives, airline representatives, or tour guides.

19. The computer-readable media of claim 8, wherein a trip includes a pre-packaged tour.
